(19) United States
(12) Patent Application Publication
(10) Pub. No.: US 2003/0150343 A1
(43) Pub. Date: Aug. 14, 2003

(54) Self inking hand stamp

(76) Inventor: Harald Koneczny, Salzburg (AT)

Correspondence Address: Law Offices of Karl Hormann, PO Box 381516, Cambridge, MA, 02238-1516, US

(21) Appl. No.: 10/239,737

(22) PCT Filed: Jan. 23, 2002
(86) PCT No.: PCT/AT02/00023

(30) Foreign Application Priority Data
Jan. 25, 2001 (AT) A 122/2001

(51) Int. Cl. B41K 1/42

(52) U.S. Cl. 101/333

(57) ABSTRACT

Self inking stamp with a stamp housing (1) for receiving a stamp platen (2) with a printing element (3) which by a swivel mechanism (5) may be swivelingly moved within the housing from a position in which the printing element engages a stamp pad (4) into a printing position, the stamp platen being actuatable by an actuator (6) stretching over the housing and coupled to the stamp platen, the actuator being latchable in a latching position of the stamp with the stamp housing by latching elements (7″), the latching elements being formed at the free ends of a separate bow (7) which may be snap-fitted over the actuator and forming an upper display window (S) of the actuator and the latching elements of which may be moved into engagement with latching elements (1″) of the housing through recesses (6″) in the side walls (6′) of the actuator.

### BACKGROUND OF THE INVENTION

1. Field of the Invention

The invention relates to a self inking stamp having a stamp housing for receiving a stamp platen with a printing element which may be swivelingly moved by a swivel mechanism within the housing from a position in which the printing element engages a stamp pad disposed within the housing into a printing position, the stamp platen being actuable by an actuator connected to the stamp platen and stretching over the housing and which in a latched position of the stamp may be snap-connected to the stamp housing by latching elements.

2. The Prior Art

In prior art stamps of this kind, resiliently deformable tongues are cut out of the side walls of the actuator which in a compressed latching position of the stamp engage lugs in the housing.

The drawback of such a construction is that complex tooling is required to form latching tongues in the side walls of the actuator and that its manual engagement surface is small.

### OBJECT OF THE INVENTION

It is an object of the invention to simplify the manufacture of the stamp.

### BRIEF SUMMARY OF THE INVENTION

This is accomplished by forming latch elements at the free ends of a separate bow snap-fitted over the actuator while and also forming an upper display window on the actuator, the latch elements engaging latches in the housing through recesses in the side walls of the actuator.

The fabrication of the stamp latching mechanism thus becomes wholly separated from the fabrication of the actuator, and the manufacture of the components is significantly simplified. Moreover, as a result of the bow the manual engagement surfaces are broader.

### DESCRIPTION OF THE SEVERAL DRAWINGS

The novel features which are considered to be characteristic of the invention are set forth with particularity in the appended claims. The invention itself, however, in respect of its structure, construction and lay-out as well as manufacturing techniques, together with other objects and advantages thereof, will be best understood from the following description of preferred embodiments when read in connection with the appended drawings, in which:

FIG. 1 is a schematic sectional view of a stamp and of the bow in accordance with the invention;

FIG. 2 is a sectional perspective view of the finished stamp;

FIG. 3 is a sectional view of the stamp in its operative state; and

FIG. 4 is a sectional view of the stamp in its latched state.

### DETAILED DESCRIPTION OF THE PREFERRED EMBODIMENT

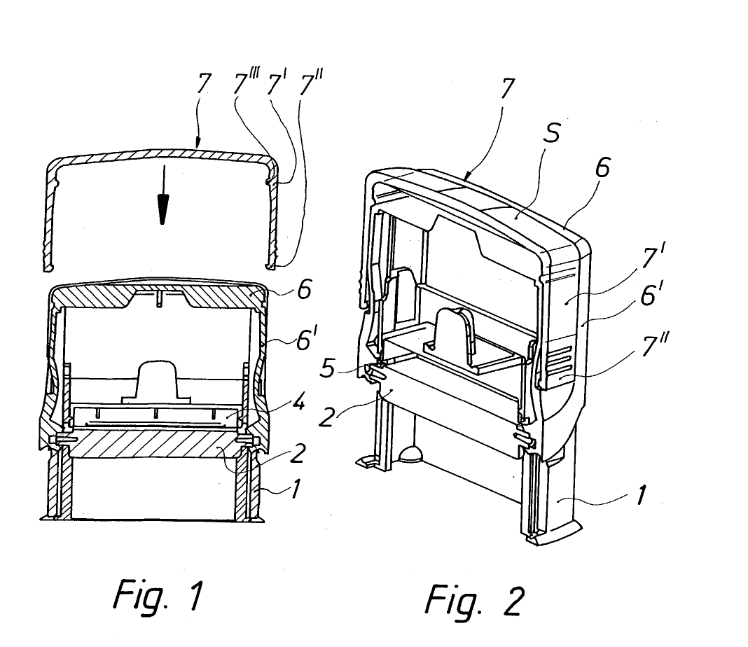

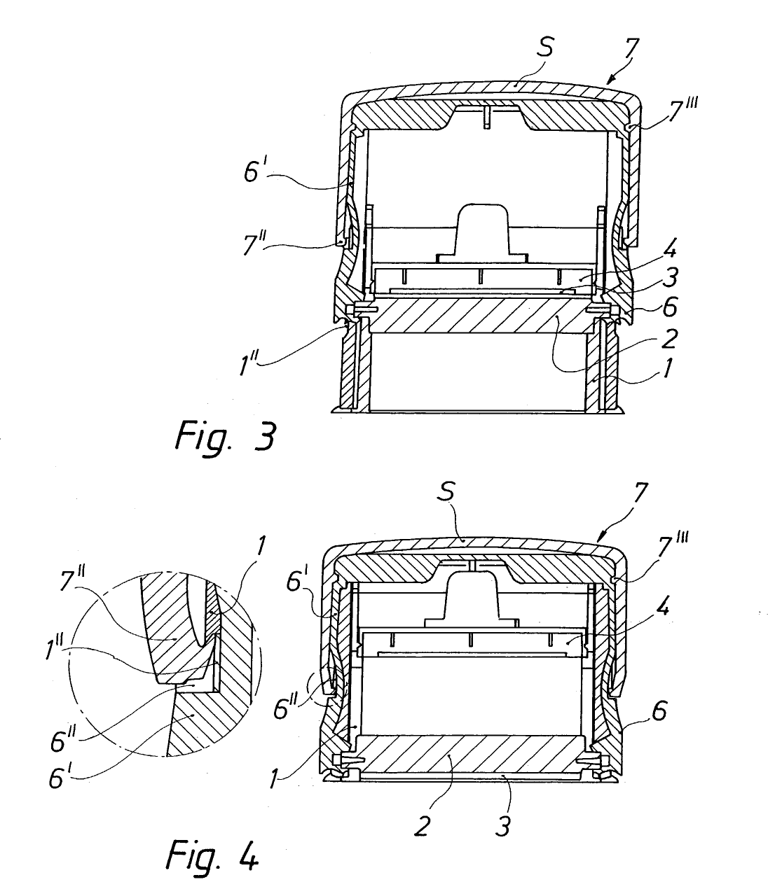

As shown in FIGS. 1 and 2, a stamp made of polymeric material has a housing 1 for receiving a stamp platen 2 which supports a printing plate 3. In its inoperative position, the printing plate 3 engages a stamp pad 4. By means of a swivel mechanism 5, the stamp platen 2 may move the printing element 3 into a printing position by an actuator 6 connected to the stamp platen 2, against the bias of a return spring (not shown) acting between the housing 1 and the actuator 6.

As may be seen in FIG. 1, a U-shaped bow 7 is snap-fitted over the actuator 6 by lugs 7′″, the bow 7 being provided at the free ends of its legs 7′ with snap hooks 7″ which, through recesses 6″ in the side walls 6′ of the actuator 6, may be moved into engagement with recesses 1″ in the housing 1.

The fabrication of the actual actuator is thus separated from the fabrication of the snap-connection of the actuator 6 and the housing 1 in the compressed latching position of the stamp as shown in FIG. 4 and, more particularly, the manufacture of the actuator 6 is simplified. Moreover, a window S is formed for displaying any legend of the stamp, and, relative to the tongues in the side walls of the actuator of prior art devices, the actuation of the stamp in its latching position is simplified owing to the greater flexibility and engagement surface of the end of the legs of the bow.

1. Self inking stamp with a stamp housing for receiving a stamp platen with a printing element which by a swivel mechanism may be swivelingly moved in the housing from a position in which the printing element engages a stamp pad disposed within the housing into a printing position, the stamp platen being actuable by an actuator encasing the housing and connected to the stamp platen which actuator in a latched position of the stamp may be latched to the stamp housing by latching elements, characterized by the fact that the latching elements (7″) are formed at the free ends of a separate bow (7) which may be snap-fitted to the actuator (6), the bow (7) forming an upper display window (S) of the actuator (6) and the latching elements (7″) of which may engage housing latches (1″) through recesses (6″) in the side walls (6′) of the actuator (6).

2. Self inking stamp according to claim 1, characterized by the fact that the bow (7) may snap-fitted onto the actuator (6) by latching lugs (7′″) at the legs (7′) of the bow.
